(19) United States
(12) Patent Application Publication
(10) Pub. No.: US 2009/0252429 A1
(43) Pub. Date: Oct. 8, 2009

(54) SYSTEM AND METHOD FOR DISPLAYING RESULTS OF AN IMAGE PROCESSING SYSTEM THAT HAS MULTIPLE RESULTS TO ALLOW SELECTION FOR SUBSEQUENT IMAGE PROCESSING

(76) Inventors: Dan Prochazka, Pacifica, CA (US); Mark Rollins, Berkeley, CA (US)

Correspondence Address: JONES DAY, 222 EAST 41ST ST, NEW YORK, NY, 10017, US

(21) Appl. No.: 12/062,496

(22) Filed: Apr. 3, 2008

(51) Int. Cl. G06K 9/36

(52) U.S. Cl. 382/254

(57) ABSTRACT

Systems and methods for processing an initial digital image that comprises a foreground object and a background are provided in which the initial image is displayed on a display. A plurality of instances of an image segmentation technique are performed to the initial image, where the segmentation technique differentiates between the foreground object and the background in the initial image, thereby creating a plurality of processed images of the initial image. A first instance of the image segmentation technique uses a different parameter set than a second instance of the image segmentation technique. Each respective instance of the image segmentation technique creates a processed image corresponding to the respective instance of the image segmentation technique. Each such processed image is concurrently displayed at a time when the initial image is also displayed. A selection of a processed image in the plurality of processed images is then received for further processing.

### BACKGROUND OF THE INVENTION

With the advancement, ease of use, and decline of prices for digital cameras, the number of digital photographs and images throughout the world has increased enormously. Very often, the digital photographs and images are not completely satisfactory to the persons taking or viewing them. Indeed, many computer aided techniques exist to manipulate, retouch, or otherwise edit digital photographs and images. Some companies have created software with these tools within it so the user may have all these techniques available under one all encompassing application. Examples of such software include GIMP, Picasa2, and Adobe Photoshop.

The success of these techniques has led the image processing industry to realize that users would like other more complex techniques to edit their digital images. A technique many within the industry have focused their efforts on is the automatic segmentation of an image's subject (foreground) from background (or vice versa). However, the industry has not been able to successfully fulfill this user need with a satisfactory, much less perfect, universal solution. Some have been able to provide a solution which results in a good percentage of success for images with certain attributes or characteristics, but no entity has been able to provide a universal solution.

Though the effectiveness of such techniques has proven elusive for all images, one solution proposes utilizing many solutions and then asking the user to select which solution they believe proved most effective for the technique (e.g. segmentation). To do so, the problem arises as to how to have the user select which solution they like best. Previous techniques allowed the user to select the image they would like to manipulate or edit, and then displayed the results of the technique or techniques selected. For example, FIG. 1 is a screenshot from Adobe Photoshop which provides for multiple filters which can be applied to a single “active image”. Note that each filter would provide for a different type of technique, each with a different goal in mind. Once the user has selected the technique, they can decide to either undo the edit, or keep the edit of the image and either utilize more techniques or save their immediate result (depending on the goal of the user). FIG. 2 is a screenshot from Picasa2 which also provides for many different techniques for manipulating or retouching one's digital images.

For the primitive techniques of manipulating, retouching, or otherwise editing digital images, the ability to open one image to apply different techniques has proven to be a temporary, yet effective, solution. However, for new, innovative, and complex techniques, which have proven to be much more difficult to achieve within the image processing community, the applications as seen in FIGS. 1 and 2 will not suffice. A user would much rather have an automated (or nearly automated) segmentation technique which provides for perfect and clean results as opposed to the conventional time consuming and more expensive manual methods. Unfortunately for the user, no solution exists for segmentation or other complex techniques that would provide perfect or clean results one-hundred-percent of the time. Still, the user would appreciate the ability to at least pick from a group of solutions the one which most closely meets their goal. Further, once the solution most feasible for the user is selected, the user should have the ability to subsequently apply different techniques to reach their goal (if not already met). Further, the ability to select the most feasible solution should be easy for even the novice image processing user. Further, the ability to select the most feasible solution should not be time consuming. As should be apparent, there is a long-felt and unfulfilled need to provide improved systems and methods for assisting a user in complex image processing techniques.

### SUMMARY

One aspect of the present invention provide systems and methods for processing an initial digital image (e.g. a bitmapped image or a pixmapped imaged) that comprises a foreground object and a background are provided in which the initial image is displayed on a display (e.g., a computer monitor, the memory of a graphic card, etc.). A plurality of instances of an image segmentation technique are performed to the initial image, where the segmentation technique differentiates between the foreground object and the background in the initial image, thereby creating a plurality of processed images of the initial image. A first instance of the image segmentation technique uses a different parameter set than a second instance of the image segmentation technique (e.g., a different thresholding level). Each respective instance of the image segmentation technique creates a processed digital image corresponding to the respective instance of the image segmentation technique. Each such processed digital image is concurrently displayed on the display at a time when the initial image is also displayed on the display. A selection of a processed image in the plurality of processed images is then received for further processing of the selected processed image.

Another aspect of the present invention provides a method of processing an initial digital image in which the initial digital image is displayed. In the method, a plurality of image processing techniques are concurrently performed to the initial digital image, where each respective image processing technique in the plurality of image processing techniques creates a processed image corresponding to the respective image processing technique, thereby creating a plurality of processed digital images of the initial digital image. Each processed image in the plurality of processed images is concurrently displaying at a time when the initial digital image is also displayed. Then, a selection of a processed image in the plurality of processed images is received for further processing of the selected processed image.

In some embodiments, the initial digital image comprises a foreground object and a background, a first image processing technique in the plurality of image processing techniques is an image segmentation technique that differentiates between the foreground object and the background in the initial digital image, and the processed digital image corresponding to the first image processing technique in the plurality of processed digital images does not display all or a portion of the background of the initial digital image. In some embodiments, the initial digital image comprises a foreground object and a background. In some embodiments, a first image processing technique in the plurality of image processing techniques is a first image segmentation technique using a first set of parameters to differentiate between the foreground object and the background in the initial digital image. In some embodiments, a second image processing technique in the plurality of image processing techniques is the first image segmentation technique using a second set of parameters to differentiate between the foreground object and the background in the initial digital image, the processed digital image corresponding to the first image processing technique with the first set of parameters in the plurality of processed digital images does not display all or a portion of the background of the initial digital image, and the processed digital image corresponding to the first image processing technique with the second set of parameters in the plurality of processed digital images does not display all or a portion of the background of the initial digital image. In some embodiments, the plurality of image processing techniques comprises three or more image processing techniques. In some embodiments, a first image processing technique in the plurality of image processing techniques uses the same image processing algorithm as a second image processing technique in the plurality of image processing techniques, and the first image processing technique uses a different set of parameters than the second image processing technique.

Another aspect of the present invention provides a method of processing an initial digital image that comprises a foreground object and a background. The method comprises displaying the initial digital image on a display and then performing a plurality of instances of a first image segmentation technique to the initial digital image, where the first image segmentation technique differentiates between the foreground object and the background in the initial digital image, thereby creating a plurality of processed digital images of the initial digital image, where a first instance of the first image segmentation technique uses a different parameter set than a second instance of the first image segmentation technique, and each respective instance of the first image segmentation technique creates a processed image corresponding to the respective instance of the first image segmentation technique. In some embodiments, the initial digital image is not displayed on the display before performing the plurality of instance of the first image segmentation technique. Continuing with the method, each processed image in the plurality of processed images is concurrently displayed on the display at a time when the initial digital image is also displayed on the display. A selection of a processed image in the plurality of processed images is then received for further processing of the selected processed image.

In some embodiments, a first processed digital image corresponding to a first instance of the first image segmentation technique in the plurality of processed digital images contains the background of the initial digital image, and pixel values in all or a portion of the background in the first processed digital image differ from pixel values for corresponding pixels in all or a portion of the background in the initial digital image. In some embodiments, the plurality of instances of the first image segmentation technique comprises three or more instances, and the plurality of processed digital images comprises three or more images. In some embodiments, the performing step further comprises performing a plurality of instances of a second image processing technique to the digital image, the second image segmentation technique differentiates between the foreground object and the background in the initial image thereby creating processed digital images of the initial digital image in the plurality of processed images, a first instance of the second image segmentation technique in the plurality of instances of the second image processing technique uses a different parameter set than a second instance of the second image segmentation technique, and each respective instance of the second image segmentation technique creates a processed image corresponding to the respective instance of the first image segmentation technique. In some embodiments, the first image segmentation technique is a thresholding technique, the parameter set for the first instance of the first image segmentation technique comprises a first threshold value, the parameter set for the second instance of the first image segmentation technique comprises a second threshold value, and the first threshold value is different than the second threshold value. In some embodiments, the first image segmentation technique is a clustering method, a histogram-based method, an edge detection method, a region growing method, a level set method, a graph partitioning method, a watershed transformation, a model segmentation method, a multi-scale segmentation, a semi-automatic segmentation, or a neural network segmentation.

One aspect of the present invention comprises a system for performing any of the methods disclosed herein. One aspect of the invention provides a system for processing an initial digital image that comprises a foreground object and a background. This system comprises means for displaying the initial digital image on a display as well as means for performing a plurality of instances of a first image segmentation technique to the initial digital image, where the first image segmentation technique differentiates between the foreground object and the background in the initial digital image, thereby creating a plurality of processed digital images of the initial digital image, and where a first instance of the first image segmentation technique uses a different parameter set than a second instance of the first image segmentation technique. Each respective instance of the first image segmentation technique creates a processed image corresponding to the respective instance of the first image segmentation technique. The system further comprises means for concurrently displaying on the display each processed image in the plurality of processed images at a time when the initial digital image is also displayed on the display and means for receiving a selection of a processed image in the plurality of processed images for further processing of the selected image.

One aspect of the present invention comprises a computer program product for use in conjunction with a computer system, the computer program product comprising a computer readable storage medium and a computer program mechanism embedded therein for processing an initial digital image that comprises a foreground object and a background. The computer program mechanism comprises instructions for carrying out any of the methods disclosed herein.

One aspect of the present invention comprises a computer program product for use in conjunction with a computer system, the computer program product comprising a computer readable storage medium and a computer program mechanism embedded therein for processing an initial digital image that comprises a foreground object and a background. The computer program mechanism comprises instructions for displaying the initial digital image on a display and performing a plurality of instances of a first image segmentation technique to the initial digital image, where the first image segmentation technique differentiates between the foreground object and the background in the initial digital image, thereby creating a plurality of processed digital images of the initial digital image. A first instance of the first image segmentation technique uses a different parameter set than a second instance of the first image segmentation technique and each respective instance of the first image segmentation technique creates a processed image corresponding to the respective instance of the first image segmentation technique. The computer program mechanism further comprises instructions for concurrently displaying on the display each processed image in the plurality of processed images at a time when the initial digital image is also displayed on the display and instructions for receiving a selection of a processed image in the plurality of processed images for further processing of the selected image.

One aspect of the present invention is a computer or other apparatus comprising a main memory, a processor, and one or more programs for processing an initial digital image that comprises a foreground object and a background, stored in the main memory and executed by the processor, the one or more programs collectively including instructions for carrying out any of the methods disclosed herein.

One aspect of the present invention is a computer or other apparatus comprising a main memory, a processor, and one or more programs for processing an initial digital image that comprises a foreground object and a background, stored in the main memory and executed by the processor, the one or more programs collectively including instructions for displaying the initial digital image on a display and for performing a plurality of instances of a first image segmentation technique to the initial digital image, wherein the first image segmentation technique differentiates between the foreground object and the background in the initial digital image, thereby creating a plurality of processed digital images of the initial digital image. A first instance of the first image segmentation technique uses a different parameter set than a second instance of the first image segmentation technique. Each respective instance of the first image segmentation technique creates a processed image corresponding to the respective instance of the first image segmentation technique. The one or more programs further collectively includes instructions for concurrently displaying on the display each processed image in the plurality of processed images at a time when the initial digital image is also displayed on the display as well as instructions for receiving a selection of a processed image in the plurality of processed images for further processing.

### BRIEF DESCRIPTION OF DRAWINGS

The accompanying drawings, which are included as part of the present specification, illustrate the presently preferred embodiments and together with the general description given above and the detailed description of the preferred embodiments given below serve to explain and teach the principles of the present invention.

FIG. 1 is a sample screenshot from Adobe Photoshop in accordance with the prior art.

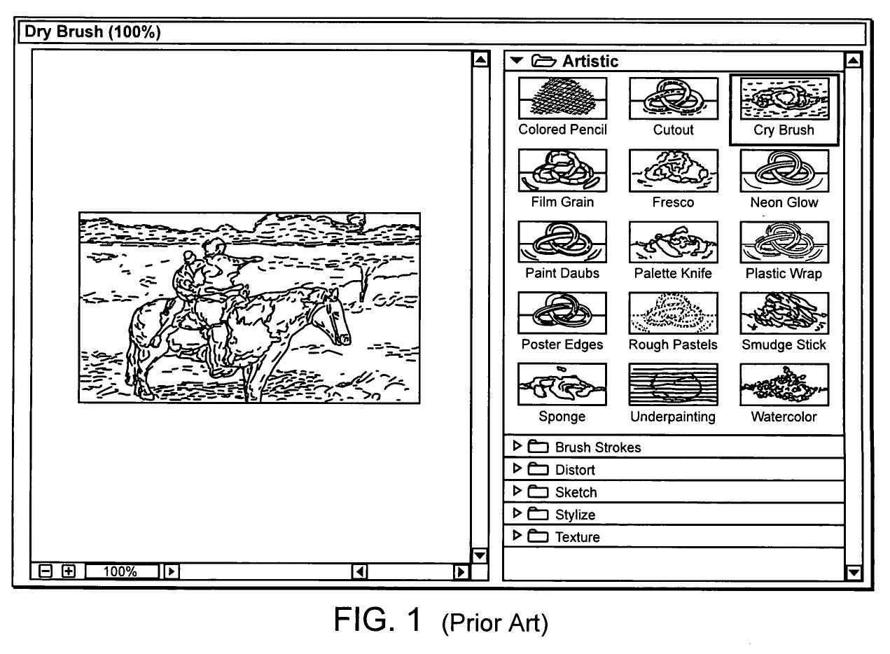

FIG. 2 is a sample screenshot from Picasa2 in accordance with the prior art.

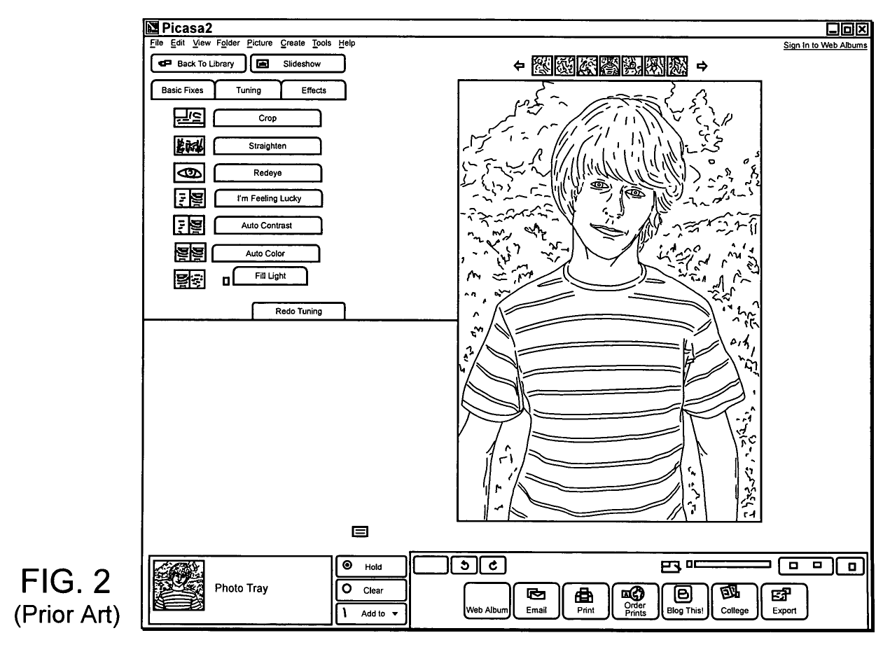

FIG. 3 comprises of a sample image and the same image processed by a technique known as image segmentation of a subject (foreground) from background which may be considered a universal solution for the technique.

FIG. 4 is a diagrammatic illustration of a system and method for displaying results of an image processing system that has multiple results (or solutions), according to one embodiment of the present invention.

FIG. 5 is an illustrative example of a screenshot from an application displaying one of the capabilities of the present invention according to one embodiment.

FIG. 6 is a block diagram of an exemplary computer architecture for use with the present system, according to one embodiment of the present invention.

### DETAILED DESCRIPTION

Systems and methods for displaying results of an image processing system that has multiple results to allow selection for subsequent image processing are disclosed.

In the following description, for purposes of explanation, specific nomenclature is set forth to provide a thorough understanding of the various inventive concepts disclosed herein. However it will be apparent to one skilled in the art that these specific details are not required in order to practice the various inventive concepts disclosed herein.

Some portions of the detailed description that follow are presented in terms of algorithms (techniques) and symbolic representations of operations on data bits within a computer memory. These algorithmic descriptions and representations are the means used by those skilled in the data processing arts to most effectively convey the substance of their work to others skilled in the art. An algorithm (technique) is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission, or display devices.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk, including floppy disks, optical disks, CD-ROMS, and magnetic-optical disks, read-only memories (“ROMs”), random access memories (“RAMs”), EPROMs, EEPROMs, magnetic or optical cards, or any type of media suitable for storing electronic instructions, and each optionally coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the inventions as described herein.

In some embodiments an image is a bitmapped or pixmapped image. As used herein, a bitmap or pixmap is a type of memory organization or image file format used to store digital images. A bitmap is a map of bits, a spatially mapped array of bits. Bitmaps and pixmaps refer to the similar concept of a spatially mapped array of pixels. Raster images in general may be referred to as bitmaps or pixmaps. In some embodiments, the term bitmap implies one bit per pixel, while a pixmap is used for images with multiple bits per pixel. One example of a bitmap is a specific format used in Windows that is usually named with the file extension of .BMP (or .DIB for device-independent bitmap). Besides BMP, other file formats that store literal bitmaps include InterLeaved Bitmap (ILBM), Portable Bitmap (PBM), X Bitmap (XBM), and Wireless Application Protocol Bitmap (WBMP). In addition to such uncompressed formats, as used herein, the term bitmap and pixmap refers to compressed formats. Examples of such bitmap formats include, but are not limited to, formats, such as JPEG, TIFF, PNG, and GIF, to name just a few, in which the bitmap image (as opposed to vector images) is stored in a compressed format. JPEG is usually lossy compression. TIFF is usually either uncompressed, or losslessly Lempel-Ziv-Welch compressed like GIF. PNG uses deflate lossless compression, another Lempel-Ziv variant. More disclosure on bitmap images is found in Foley, 1995, Computer Graphics: Principles and Practice, Addison-Wesley Professional, p. 13, ISBN 0201848406 as well as Pachghare, 2005, Comprehensive Computer Graphics: Including C++, Laxmi Publications, p. 93, ISBN 8170081858, each of which is hereby incorporated by reference herein in its entirety.

In typical uncompressed bitmaps, image pixels are generally stored with a color depth of 1, 4, 8, 16, 24, 32, 48, or 64 bits per pixel. Pixels of 8 bits and fewer can represent either grayscale or indexed color. An alpha channel, for transparency, may be stored in a separate bitmap, where it is similar to a greyscale bitmap, or in a fourth channel that, for example, converts 24-bit images to 32 bits per pixel. The bits representing the bitmap pixels may be packed or unpacked (spaced out to byte or word boundaries), depending on the format. Depending on the color depth, a pixel in the picture will occupy at least n/8 bytes, where n is the bit depth since 1 byte equals 8 bits. For an uncompressed, packed within rows, bitmap, such as is stored in Microsoft DIB or BMP file format, or in uncompressed TIFF format, the approximate size for a n-bit-per-pixel (2n colors) bitmap, in bytes, can be calculated as: size width×height×n/8, where height and width are given in pixels. In this formula, header size and color palette size, if any, are not included. Due to effects of row padding to align each row start to a storage unit boundary such as a word, additional bytes may be needed.

As mentioned above, complex and innovative techniques of image processing have emerged from the large number of digital images created by the many users of digital cameras. These complex and innovative techniques include many different solutions for image processing including segmentation of objects within an image, classification, feature extraction, and pattern recognition. It should be apparent to one skilled in the arts that there are many different complex and innovative techniques and the examples provided are not exhaustive. The present invention will apply to all complex and innovative techniques and it is one advantage of the present invention that it is capable of handling the many different techniques. See, for example, The Image Processing Handbook, Fourth Edition, 2002, CRC Press LLC, Boca Raton, Fla., which is hereby incorporated by reference herein for such purpose. For example only, this description for the present invention will continue with the segmentation of image subject (foreground) or background technique. Exemplary segmentation techniques are disclosed in The Image Processing Handbook, Fourth Edition, 2002, CRC Press LLC, Boca Raton, Fla., Chapter 6, which is hereby incorporated by reference herein for such purpose.

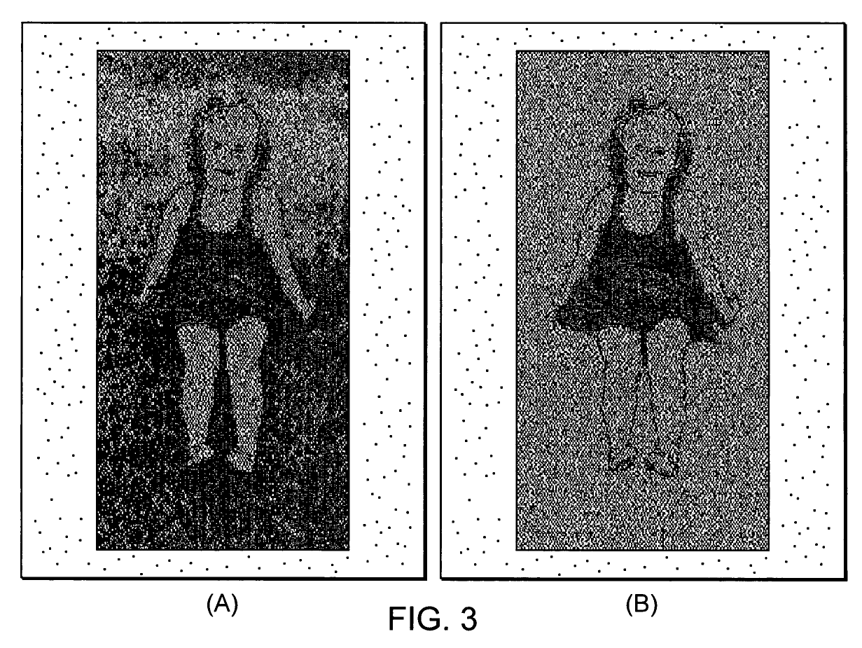

The technique of automated segmentation of an image's subject (foreground from background or vice versa) is a concept that has proven elusive to many within the image processing community. Sample image (A) with perfect and clean segmentation (B) of that image are provided in FIG. 3. In this example, the technique of image processing sought is the ability for automated segmentation of an image's subject (foreground) from the background. Problems arise when trying to provide a solution for this technique which would prove effective for every image processed.

Examples of solutions for the sought technique of image segmentation include, “Systems and Methods for Rule-Based Segmentation for Vertical Person of People With Full or Partial Frontal View in Color Images,” Provisional Patent Pending, Application No. 61/013,984 (which is hereby incorporated by reference herein in its entirety) and “System and Method for Segmenting an Image Based on Perceptual Information,” Provisional Patent Pending, Application No. 60/909,912 (which is hereby incorporated by reference herein in its entirety). As should be apparent to one skilled in the art, the solutions described in the applications referenced provide different systems and methods. As should further be apparent to one skilled in the art, each solution described in each application referenced can also provide different solutions by adjusting or changing certain parameters.

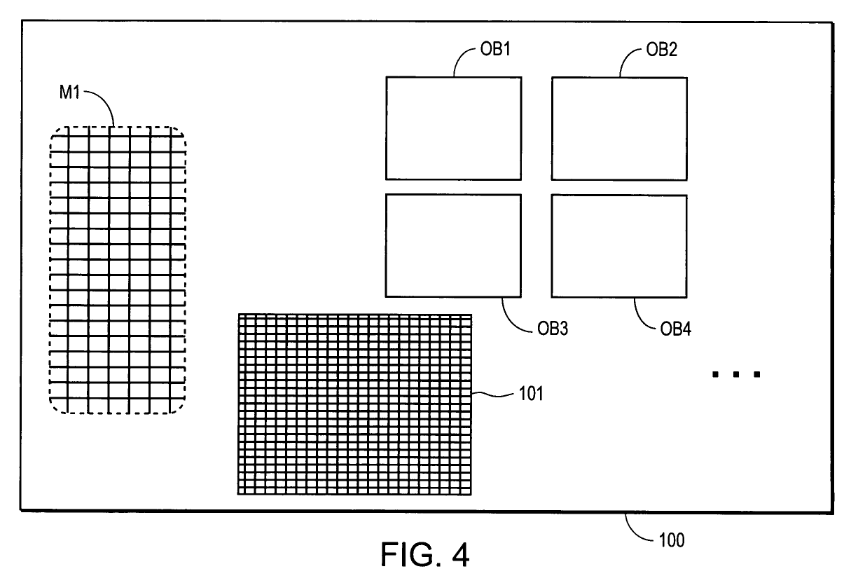

FIG. 4 is a diagrammatic illustration of a system and method for displaying results of an image processing system that has multiple results (or solutions), according to one embodiment of the present invention. In one embodiment, element 100 represents a viewing panel, computer monitor, television, or any other viewing device or display. In one embodiment, element 100 represents an object on the screen of a viewing panel, computer monitor, television, or any other viewing device or display. In one embodiment of the present invention, element 100 comprises two objects labeled OB1 and OB2. Objects OB1 and OB2 comprise the results from solutions for the technique the user utilizes for image processing of the same image. In one embodiment, OB1 and OB2 each display an image to which an image processing technique has been applied. In one embodiment, OB1 displays the result of a first solution while OB2 displays the result of a second solution. In one embodiment, the solutions utilized in OB1 and OB2 are different yet are designed for the same image processing technique (e.g. the same goal in image processing). In one embodiment, the solutions utilized in OB1 and OB2 are different and are designed for different image processing techniques. In one embodiment, element 100 comprises more than two objects, more than three objects, more than five objects, or more than ten objects (as represented by OB3, OB4, . . . , OBN) for displaying solutions for image processing techniques for the same image where each object displays the results of a different solution. In one embodiment, all objects OBN display the results of a different solution for the same image processing technique.

In one embodiment, element 100 comprises, or in some way communicates with, M1. M1 provides the user with the ability to select the image to be processed for a certain technique. For example, M1 may display or hold a collection of images. The user is able to select the image or images to be processed from M1 and apply the technique or techniques on the image. The solutions for the image would display in OB1 and OB2 (and possibly other objects if available) as described above.

In one embodiment, element 100 comprises portion 101 which displays the selection of the solution by the user. For example, the user may select a technique the user wishes to use to process an image, where the solutions for the technique display in OB1 and OB2 (and other objects OB3, OB4, . . . OBN if available and desired). The user may then select which object (result) the user determines provides the most appropriate solution. The selection may be done by a number of selecting tools, such as a computer mouse, touch screen, keyboard, joystick, or any other selection tool or device. Once selected, the solution result display in portion 101.

In one embodiment, portion 101 will immediately display any of the solutions as default or as an automated best choice. In one embodiment, element 100 provides one or more primitive techniques for use by a user in addition to one or more segmentation techniques or other complex techniques. As used herein, a primitive technique is a technique that typically does not require manual or automated refinement of parameters that affect the technique whereas a complex technique is one that typically does require user manual or automated refinement of parameters that affect the technique. It is recognized that there may be some overlap between those techniques that are deemed to be primitive and those that are deemed to be complex. However, the point is that the system and the method of the present invention provides a wide range of image processing techniques for use by a user in addition to those techniques that are run a plurality of times with different parameter values.

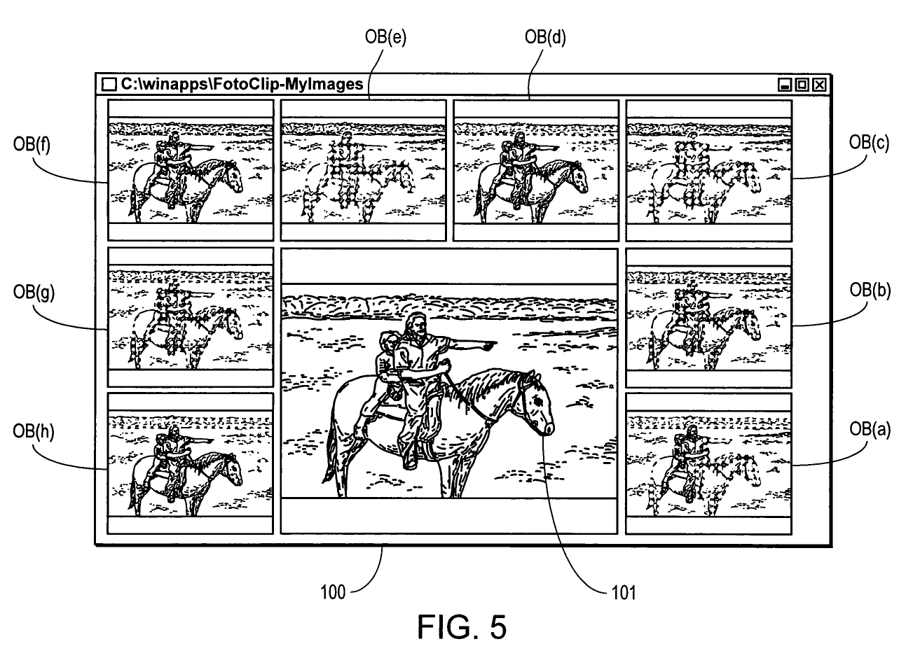

FIG. 5 is an illustrative example of a screenshot from an application displaying one of the capabilities of the present invention according to one embodiment. This embodiment utilizes seven different solutions to the technique of image segmentation of the foreground from the background. The seven different solutions are displayed in objects OB(a), OB(b), OB(d), OB(e), OB(f), OB(g), and OB(h). In this embodiment, element 100 comprises the display of the original image as well, as seen in OB(c). In one embodiment, portion 101 displays the solution determined to be the best solution for the original image OB(c) as a default. In one embodiment, portion 101 displays the object containing the solution the user has selected as the chosen solution. In FIG. 5, element 101 is displaying the image processed solution of OB(a). Once the desired solution has been selected by the user (or if default is chosen), the user may decide whether to do further techniques for image processing upon the image. In some embodiments, each of the different solutions is achieved using the same image processing technique (e.g., the same segmentation technique) with different values for one or more parameters associated with the image processing technique. For example, in one instance, the image processing technique is thresholding and each of the solutions is achieved by thresholding an initial digital image using a different threshold. In some embodiments, each of the different solutions is achieved using two or more different image processing techniques. In some embodiments, some of the different solutions are achieved using a first image processing techniques and some of the different solutions are achieved using a second image processing technique. In such embodiments, each instance of the first or second image processing technique is performed using one or more different values for parameters that affect the image processing techniques.

In some embodiments, a segmentation technique used in accordance with the present invention is a clustering method such as a K-means algorithm. The K-means algorithm is an iterative technique that is used to partition an image into K clusters. The basic algorithm is

i) pick K cluster centers, either randomly or based on some heuristic;

ii) assign each pixel in the image to the cluster that minimizes the variance between the pixel and the cluster center;

iii) re-compute the cluster centers by averaging all of the pixels in the cluster; and

iv) repeat steps i and iii until convergence is attained (e.g. no pixels change clusters) In this case, variance is the squared or absolute difference between a pixel and a cluster center. The difference is typically based on pixel color, intensity, texture, and location, or a weighted combination of these factors. K can be selected manually, randomly, or by a heuristic. This algorithm is guaranteed to converge, but it may not return the optimal solution. The quality of the solution depends on the initial set of clusters and the value of K.

In some embodiments, a segmentation technique used in accordance with the present invention is a histogram-based method. Histogram-based methods typically require only one pass through the pixels. In this technique, a histogram is computed from all of the pixels in the image, and the peaks and valleys in the histogram are used to locate the clusters in the image. Color or intensity can be used as the measure. A refinement of this technique is to recursively apply the histogram-seeking method to clusters in the image in order to divide them into smaller clusters. This is repeated with smaller and smaller clusters until no more clusters are formed.

In some embodiments, a segmentation technique used in accordance with the present invention is an edge detection method. Edge detection is a well-developed field on its own within image processing. Region boundaries and edges are closely related, since there is often a sharp adjustment in intensity at the region boundaries. Edge detection techniques have therefore been used to as the base of another segmentation technique. The edges identified by edge detection are often disconnected. To segment an object from an image however, one needs closed region boundaries. Discontinuities are bridged if the distance between the two edges is within some predetermined threshold.

In some embodiments, a segmentation technique used in accordance with the present invention is a region growing method. One region growing method is the seeded region growing method. This method takes a set of seeds as input along with the image. The seeds mark each of the objects to be segmented. The regions are iteratively grown by comparing all unallocated neighboring pixels to the regions. The difference between a pixel's intensity value and the region's mean, δ, is used as a measure of similarity. The pixel with the smallest difference measured this way is allocated to the respective region. This process continues until all pixels are allocated to a region. Seeded region growing requires seeds as additional input. The segmentation results are dependent on the choice of seeds. Noise in the image can cause the seeds to be poorly placed. Unseeded region growing is a modified algorithm that doesn't require explicit seeds. It starts off with a single region A1—the pixel chosen here does not significantly influence final segmentation. At each iteration it considers the neighboring pixels in the same way as seeded region growing. It differs from seeded region growing in that if the minimum δ is less than a then a predefined threshold T then it is added to the respective region Aj. If not, then the pixel is considered significantly different from all current regions Ai and a new region An+1 is created with this pixel. One variant of this technique, proposed by Haralick and Shapiro, 1985, Computer Vision, pp. 279-325, Prentice-Hall, New Jersey, which is hereby incorporated by reference herein, is based on pixel intensities. The mean and scatter of the region and the intensity of the candidate pixel is used to compute a test statistic. If the test statistic is sufficiently small, the pixel is added to the region, and the region's mean and scatter are recomputed. Otherwise, the pixel is rejected, and is used to form a new region.

In some embodiments, a segmentation technique used in accordance with the present invention is a level set method such as curve propagation. Curve propagation is used for object extraction, object tracking, stereo reconstruction, etc. The central idea behind such an approach is to evolve a curve towards the lowest potential of a cost function, where its definition reflects the task to be addressed and imposes certain smoothness constraints. Langragian techniques are based on parameterizing the contour according to some sampling strategy and then evolve each element according to image and internal terms. While such a technique can be very efficient, it suffers from various limitations like deciding on the sampling strategy, estimating the internal geometric properties of the curve, changing its topology, addressing problems in higher dimensions, etc. The level set method can be used to efficiently address the problem of curve/surface/etc. propagation in an implicit manner. The central idea is represent the evolving contour using a signed function, where its zero level corresponds to the actual contour. Then, according to the motion equation of the contour, one can easily derive a similar flow for the implicit surface that when applied to the zero-level will reflect the propagation of the contour. The level set method encodes numerous advantages: it is implicit, parameter free, provides a direct way to estimate the geometric properties of the evolving structure, can change the topology and is intrinsic. Furthermore, they can be used to define an optimization framework. Therefore, one can conclude that it is a very convenient framework to address numerous applications of computer vision and medical image analysis. See, for example, Osher and Paragios, 2003, Geometric Level Set Methods in Imaging Vision and Graphics, Springer Verlag, which is hereby incorporated by reference herein in its entirety.

In some embodiments, a segmentation technique used in accordance with the present invention is a graph partitioning method such as the “normalized cuts” method. See, for example, Shi and Malik, 1997, “Normalized Cuts and Image Segmentation,” IEEE Conference on Computer Vision and Pattern Recognition, pp. 731-737, which is hereby incorporated by reference herein in its entirety. In the “normalized cuts” method, the image being segmented is modeled as a weighted undirected graph. Each pixel is a node in the graph, and an edge is formed between every pair of pixels. The weight of an edge is a measure of the similarity between the pixels. The image is partitioned into disjoint sets (segments) by removing the edges connecting the segments. The optimal partitioning of the graph is the one that minimizes the weights of the edges that were removed (the “cut”). Shi's algorithm seeks to minimize the “normalized cut”, which is the ratio of the “cut” to all of the edges in the set.

In some embodiments, a segmentation technique used in accordance with the present invention is a watershed transformation. The watershed transformation considers the gradient magnitude of an image as a topographic surface. Pixels having the highest gradient magnitude intensities (GMIs) correspond to watershed lines, which represent the region boundaries. Water placed on any pixel enclosed by a common watershed line flows downhill to a common local intensity minima (LMI). Pixels draining to a common minimum form a catchment basin, which represent the regions.

In some embodiments, a segmentation technique used in accordance with the present invention is a model based segmentation. The central assumption of such an approach is that structures of interest/organs have a repetitive form of geometry. Therefore, one can seek for a probabilistic model towards explaining the variation of the shape of the organ and then when segmenting an image impose constraints using this model as prior. Such a task involves (i) registration of the training examples to a common pose, (ii) probabilistic representation of the variation of the registered samples, and (iii) statistical inference between the model and the image. Methods in the literature for knowledge-based segmentation involve active shape and appearance models, active contours and deformable templates and level-set based methods.

In some embodiments, a segmentation technique used in accordance with the present invention is a multi-scale segmentation in which image segmentations are computed at multiple scales in scale-space and sometimes propagated from coarse to fine scales. Segmentation criteria can be arbitrarily complex and may take into account global as well as local criteria. A common requirement is that each region must be connected in some sense.

In some embodiments, a segmentation technique used in accordance with the present invention is a semi-automatic segmentation. In this kind of segmentation, the user outlines the region of interest with the mouse clicks and algorithms are applied so that the path that best fits the edge of the image is shown.

In some embodiments, a segmentation technique used in accordance with the present invention is a neural networks segmentation. A neural network segmentation relies on processing small areas of an image using a neural network or a set of neural networks. After such processing the decision-making mechanism marks the areas of an image accordingly to the category recognized by the neural network.

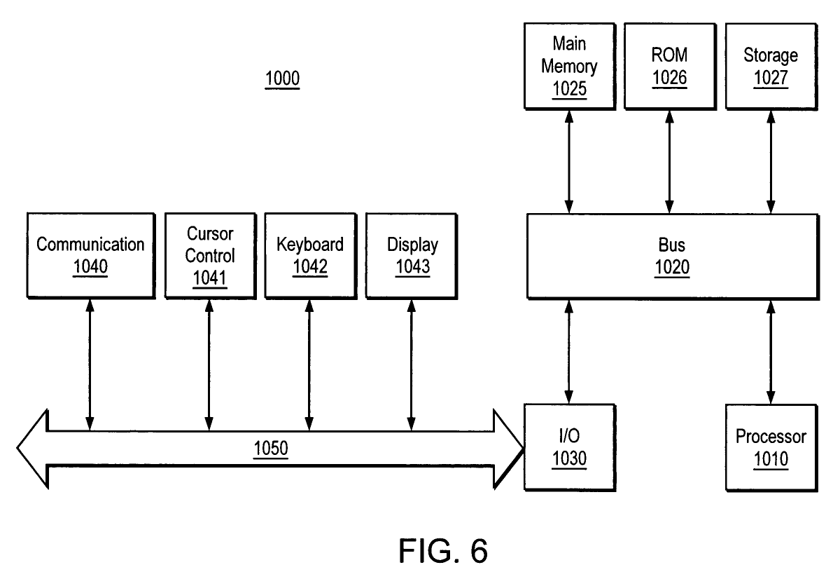

FIG. 6 is an illustration of an exemplary computer architecture for use with the present system, according to one embodiment. Computer architecture 1000 is used to implement the computer systems or image processing systems described in various embodiments of the invention. One embodiment of architecture 1000 comprises a system bus 1020 for communicating information, and a processor 1010 coupled to bus 1020 for processing information. Architecture 1000 further comprises a random access memory (RAM) or other dynamic storage device 1025 (referred to herein as main memory), coupled to bus 1020 for storing information and instructions to be executed by processor 1010. Main memory 1025 is used to store temporary variables or other intermediate information during execution of instructions by processor 1010. Architecture 1000 includes a read only memory (ROM) and/or other static storage device 1026 coupled to bus 1020 for storing static information and instructions used by processor 1010.

A data storage device 1027 such as a magnetic disk or optical disk and its corresponding drive is coupled to computer system 1000 for storing information and instructions. Architecture 1000 is coupled to a second I/O bus 1050 via an I/O interface 1030. A plurality of I/O devices may be coupled to I/O bus 1050, including a display device 1043, an input device (e.g., an alphanumeric input device 1042 and/or a cursor control device 1041).

The communication device 1040 is for accessing other computers (servers or clients) via a network. The communication device 1040 may comprise a modem, a network interface card, a wireless network interface, or other well known interface device, such as those used for coupling to Ethernet, token ring, or other types of networks.

Foregoing described embodiments of the invention are provided as illustrations and descriptions. They are not intended to limit the invention to precise form described. In particular, it is contemplated that functional implementation of invention described herein may be implemented equivalently in hardware, software, firmware, and/or other available functional components or building blocks, and that networks may be wired, wireless, or a combination of wired and wireless. Other variations and embodiments are possible in light of above teachings, and it is thus intended that the scope of invention not be limited by this detailed description, but rather by the claims following.

What is claimed:

1. A method of processing an initial digital image that comprises a foreground object and a background, the method comprising:
displaying the initial digital image on a display;
performing a plurality of instances of a first image segmentation technique to the initial digital image, wherein the first image segmentation technique differentiates between the foreground object and the background in the initial digital image, thereby creating a plurality of processed digital images of the initial digital image, wherein
a first instance of the first image segmentation technique uses a different parameter set than a second instance of the first image segmentation technique; and
each respective instance of the first image segmentation technique creates a processed image corresponding to the respective instance of the first image segmentation technique;
concurrently displaying on the display each processed image in the plurality of processed images at a time when the initial digital image is also displayed on the display; and
receiving a selection of a processed image in the plurality of processed images for further processing.

2. The method of claim 1, wherein
a first processed digital image corresponding to a first instance of the first image segmentation technique in the plurality of processed digital images contains the background of the initial digital image; and
pixel values in all or a portion of the background in the first processed digital image differ from pixel values for corresponding pixels in all or a portion of the background in the initial digital image.

3. The method of claim 1, wherein
the plurality of instances of the first image segmentation technique comprises three or more instances; and
the plurality of processed digital images comprises three or more images.

4. The method of claim 1, wherein
the performing step further comprises performing a plurality of instances of a second image processing technique to the digital image;
the second image segmentation technique differentiates between the foreground object and the background in the initial image thereby creating processed digital images of the initial digital image in the plurality of processed images;
a first instance of the second image segmentation technique in the plurality of instances of the second image processing technique uses a different parameter set than a second instance of the second image segmentation technique; and
each respective instance of the second image segmentation technique creates a processed image corresponding to the respective instance of the first image segmentation technique.

5. The method of claim 1, wherein
the first image segmentation technique is a thresholding technique;
the parameter set for the first instance of the first image segmentation technique comprises a first threshold value;
the parameter set for the second instance of the first image segmentation technique comprises a second threshold value; and
the first threshold value is different than the second threshold value.

6. The method of claim 1, wherein the first image segmentation technique is a clustering method, a histogram-based method, an edge detection method, a region growing method, a level set method, a graph partitioning method, a watershed transformation, a model segmentation method, a multi-scale segmentation, a semi-automatic segmentation, or a neural network segmentation.

7. A system for processing an initial digital image that comprises a foreground object and a background, the system comprising:
means for displaying the initial digital image on a display;
means for performing a plurality of instances of a first image segmentation technique to the initial digital image, wherein the first image segmentation technique differentiates between the foreground object and the background in the initial digital image, thereby creating a plurality of processed digital images of the initial digital image, wherein
a first instance of the first image segmentation technique uses a different parameter set than a second instance of the first image segmentation technique; and
each respective instance of the first image segmentation technique creates a processed image corresponding to the respective instance of the first image segmentation technique;
means for concurrently displaying on the display each processed image in the plurality of processed images at a time when the initial digital image is also displayed on the display; and
means for receiving a selection of a processed image in the plurality of processed images for further processing.

8. The system of claim 7, wherein
a first processed digital image corresponding to a first instance of the first image segmentation technique in the plurality of processed digital images contains the background of the initial digital image; and
pixel values in all or a portion of the background in the first processed digital image differ from pixel values for corresponding pixels in all or a portion of the background in the initial digital image.

9. The system of claim 7, wherein
the plurality of instances of the first image segmentation technique comprises three or more instances; and
the plurality of processed digital images comprises three or more images.

10. The system of claim 7, wherein
the means for performing further comprises means for performing a plurality of instances of a second image processing technique to the digital image;
the second image segmentation technique differentiates between the foreground object and the background in the initial image thereby creating processed digital images of the initial digital image in the plurality of processed images;
a first instance of the second image segmentation technique in the plurality of instances of the second image processing technique uses a different parameter set than a second instance of the second image segmentation technique; and
each respective instance of the second image segmentation technique creates a processed image corresponding to the respective instance of the first image segmentation technique.

11. The system of claim 7, wherein
the first image segmentation technique is a thresholding technique;
the parameter set for the first instance of the first image segmentation technique comprises a first threshold value;
the parameter set for the second instance of the first image segmentation technique comprises a second threshold value; and
the first threshold value is different than the second threshold value.

12. The system of claim 7, wherein the first image segmentation technique is a clustering method, a histogram-based method, an edge detection method, a region growing method, a level set method, a graph partitioning method, a watershed transformation, a model segmentation method, a multi-scale segmentation, a semi-automatic segmentation, or a neural network segmentation.

13. A computer program product for use in conjunction with a computer system, the computer program product comprising a computer readable storage medium and a computer program mechanism embedded therein for processing an initial digital image that comprises a foreground object and a background, the computer program mechanism comprising instructions for:
displaying the initial digital image on a display;
performing a plurality of instances of a first image segmentation technique to the initial digital image, wherein the first image segmentation technique differentiates between the foreground object and the background in the initial digital image, thereby creating a plurality of processed digital images of the initial digital image, wherein
a first instance of the first image segmentation technique uses a different parameter set than a second instance of the first image segmentation technique; and
each respective instance of the first image segmentation technique creates a processed image corresponding to the respective instance of the first image segmentation technique;
concurrently displaying on the display each processed image in the plurality of processed images at a time when the initial digital image is also displayed on the display; and
receiving a selection of a processed image in the plurality of processed images for further processing.

14. The computer program product of claim 13, wherein
a first processed digital image corresponding to a first instance of the first image segmentation technique in the plurality of processed digital images contains the background of the initial digital image; and
pixel values in all or a portion of the background in the first processed digital image differ from pixel values for corresponding pixels in all or a portion of the background in the initial digital image.

15. The computer program product of claim 13, wherein
the plurality of instances of the first image segmentation technique comprises three or more instances; and
the plurality of processed digital images comprises three or more images.

16. The computer program product of claim 13, wherein
the instructions for performing further comprises instructions for performing a plurality of instances of a second image processing technique to the digital image;
the second image segmentation technique differentiates between the foreground object and the background in the initial image thereby creating processed digital images of the initial digital image in the plurality of processed images;
a first instance of the second image segmentation technique in the plurality of instances of the second image processing technique uses a different parameter set than a second instance of the second image segmentation technique; and
each respective instance of the second image segmentation technique creates a processed image corresponding to the respective instance of the first image segmentation technique.

17. The computer program product of claim 13, wherein
the first image segmentation technique is a thresholding technique;
the parameter set for the first instance of the first image segmentation technique comprises a first threshold value;
the parameter set for the second instance of the first image segmentation technique comprises a second threshold value; and
the first threshold value is different than the second threshold value.

18. The computer program product of claim 13, wherein the first image segmentation technique is a clustering method, a histogram-based method, an edge detection method, a region growing method, a level set method, a graph partitioning method, a watershed transformation, a model segmentation method, a multi-scale segmentation, a semi-automatic segmentation, or a neural network segmentation.

19. A computer, comprising:
a main memory;
a processor; and
one or more programs for processing an initial digital image that comprises a foreground object and a background, stored in the main memory and executed by the processor, the one or more programs collectively including instructions for:
displaying the initial digital image on a display;
performing a plurality of instances of a first image segmentation technique to the initial digital image, wherein the first image segmentation technique differentiates between the foreground object and the background in the initial digital image, thereby creating a plurality of processed digital images of the initial digital image, wherein
a first instance of the first image segmentation technique uses a different parameter set than a second instance of the first image segmentation technique; and
each respective instance of the first image segmentation technique creates a processed image corresponding to the respective instance of the first image segmentation technique;
concurrently displaying on the display each processed image in the plurality of processed images at a time when the initial digital image is also displayed on the display; and
receiving a selection of a processed image in the plurality of processed images for further processing.

20. The computer of claim 19, wherein
a first processed digital image corresponding to a first instance of the first image segmentation technique in the plurality of processed digital images contains the background of the initial digital image; and
pixel values in all or a portion of the background in the first processed digital image differ from pixel values for corresponding pixels in all or a portion of the background in the initial digital image.

21. The computer of claim 20, wherein
the plurality of instances of the first image segmentation technique comprises three or more instances; and
the plurality of processed digital images comprises three or more images.

22. The computer of claim 20, wherein
the instructions for performing further comprises instructions for performing a plurality of instances of a second image processing technique to the digital image;
the second image segmentation technique differentiates between the foreground object and the background in the initial image thereby creating processed digital images of the initial digital image in the plurality of processed images;
a first instance of the second image segmentation technique in the plurality of instances of the second image processing technique uses a different parameter set than a second instance of the second image segmentation technique; and
each respective instance of the second image segmentation technique creates a processed image corresponding to the respective instance of the first image segmentation technique.

23. The computer of claim 20, wherein
the first image segmentation technique is a thresholding technique;
the parameter set for the first instance of the first image segmentation technique comprises a first threshold value;
the parameter set for the second instance of the first image segmentation technique comprises a second threshold value; and
the first threshold value is different than the second threshold value.

24. The computer of claim 20, wherein the first image segmentation technique is a clustering method, a histogram-based method, an edge detection method, a region growing method, a level set method, a graph partitioning method, a watershed transformation, a model segmentation method, a multi-scale segmentation, a semi-automatic segmentation, or a neural network segmentation.
